(19) United States
(12) Patent Application Publication
(10) Pub. No.: US 2026/0285287 A1
(43) Pub. Date: Sep. 24, 2026

(54) SYSTEM AND METHOD FOR CONTROLLING TRACTION MOTOR

(71) Applicant: Ford Global Technologies, LLC, Dearborn, MI (US)

(72) Inventors: Alec Bolthouse, Saline, MI (US); Andrew E. Burt, Royal Oak, MI (US); Zachary Sinisi, Royal Oak, MI (US); Sassan Farahmand, Canton, MI (US)

(21) Appl. No.: 19/083,296

(22) Filed: Mar. 18, 2025

(51) Int. Cl. B60W 20/12; B60W 10/08; B60W 50/00; B62D 15/02; H02P 6/08

(52) U.S. Cl. CPC B60W 20/12; B60W 50/00; B62D 15/021; H02P 6/08; B60W 10/08; B60W 2050/0052; B60W 2510/20; B60W 2710/083

(57) ABSTRACT

Systems and methods for managing power consumption and operation of an electric machine that is configured to provide propulsive effort of a hybrid vehicle are presented. In one example, steering angle of the hybrid vehicle is a basis for managing power consumption and operation of the electric machine so that charge stored in an electric energy storage device may be conserved.

### TECHNICAL FIELD

The present description relates to methods and a system for providing smooth driveline operation during transmission gear downshifting and engine starting.

### BACKGROUND AND SUMMARY

A hybrid vehicle may include an internal combustion engine and an electric machine (e.g., a traction motor) to propel the hybrid vehicle. The internal combustion engine may be operated at middle to high driver demands and when traction battery state of charge (SOC) is low. The electric machine may assist the internal combustion engine at higher driver demands and the electric machine may be the sole power source to propel the hybrid vehicle at low driver demands when SOC is high. However, it may be possible to operate the vehicle at conditions that cause the SOC to decline and then remain low over time. During such conditions, the electric machine may not be able to assist the internal combustion engine at higher driver demands or to propel the vehicle at light driver demands. Consequently, vehicle drivability may be reduced.

### BRIEF DESCRIPTION OF THE FIGURES

The advantages described herein will be more fully understood by reading an example of an embodiment, referred to herein as the Detailed Description, when taken alone or with reference to the drawings, where:

FIG. 1 is a schematic diagram of an engine;

FIG. 2 is a schematic diagram of a hybrid vehicle driveline including the engine of FIG. 1;

FIG. 3 shows example vehicle operating sequence where electric machine torque output may be adjusted according to steering angle;

FIG. 4 shows a block diagram of a method for adjusting torque of an electric machine; and

FIGS. 5A and 5B are schematic diagrams showing a vehicle steering angle.

### DETAILED DESCRIPTION

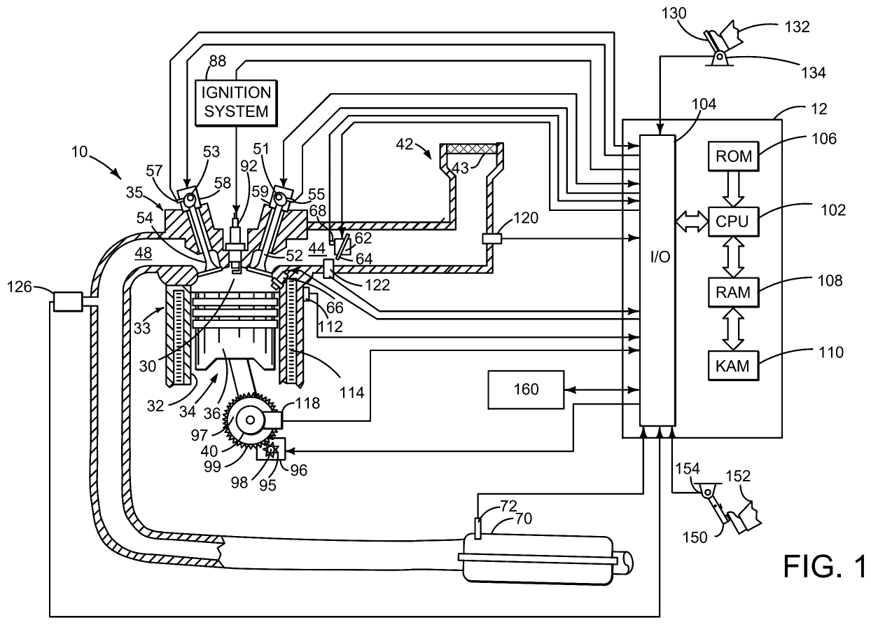

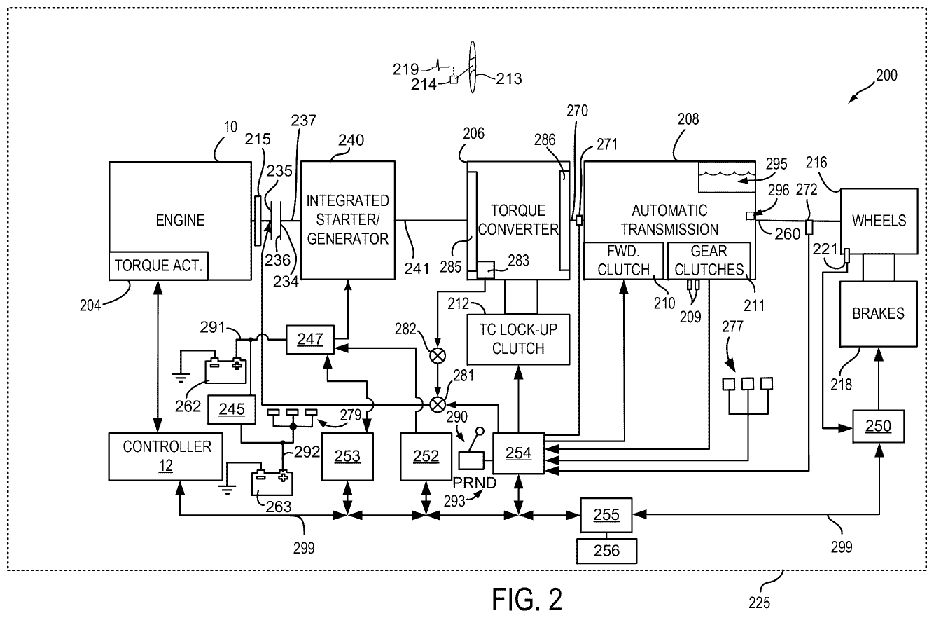

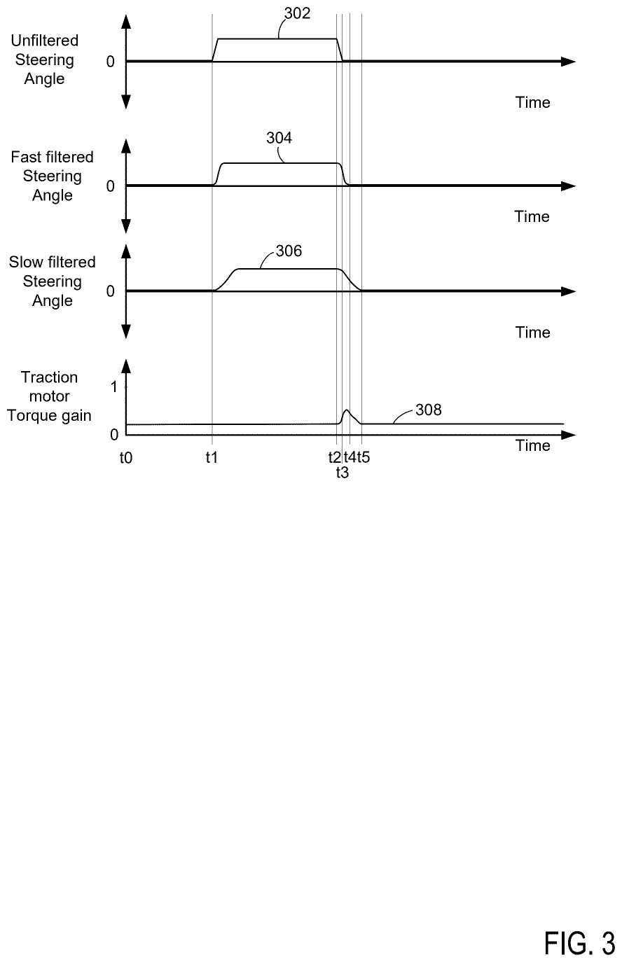

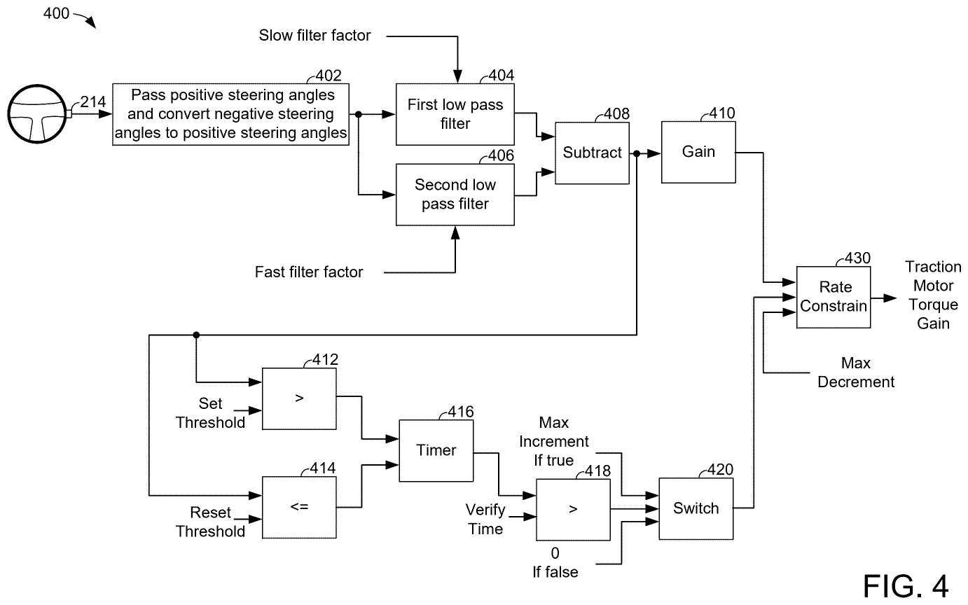

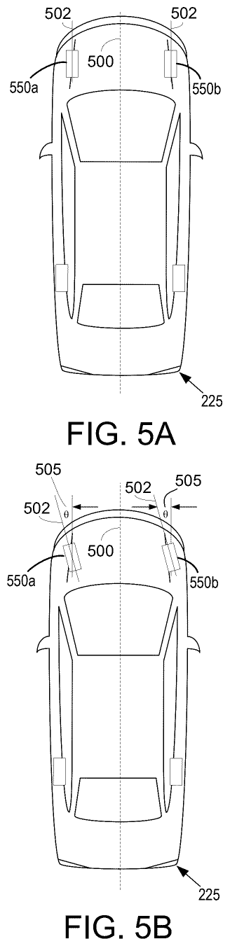

The present description is related to increasing drivability of a hybrid vehicle during sporty driving maneuvers. The increase in hybrid vehicle drivability may be a result of conserving electric machine operation and traction battery SOC so that the electric machine and battery SOC may be available for a longer time duration and when they may provide greater benefit. The hybrid vehicle may include an internal combustion engine of the type that is shown in FIG. 1. The engine may be part of a hybrid powertrain or driveline as shown in FIG. 2. An operating sequence according to the methods of FIG. 4 is shown in FIG. 3. FIG. 4 shows a block diagram of a method for operating a hybrid vehicle during sporty driving maneuvers. FIGS. 5A and 5B show a vehicle steering angle.

A hybrid vehicle may travel on roads or on a closed track where the hybrid vehicle frequently stops moving and restarts moving according to driving conditions. The frequent hybrid vehicle stops and restarts may tend to consume charge from the vehicle's traction battery. Over time, operating the hybrid vehicle under these conditions may lead to depletion of the power from the traction battery such that the hybrid vehicle's electric machine may not be able to propel the hybrid vehicle. While propelling the vehicle solely via the electric machine may be desirable at times, there may be other times when it is deemed a higher priority to propel the vehicle via the electric machine and the hybrid vehicle's internal combustion engine. Therefore, it may be desirable to provide a way of controlling use of the electric machine and traction battery so that there may be a higher likelihood of being able to rely on operation of the electric machine and traction battery during higher priority operating conditions.

The inventors herein have recognized the above-mentioned issues and have developed a method for operating a vehicle, comprising: via a controller, adjusting output of an electric machine that propels the vehicle in response to a steering angle of the vehicle.

By controlling output of an electric machine that provides propulsive effort to a vehicle based on a steering angle of the vehicle, it may be possible to conserve electric power for instances where the electric power may increase vehicle drivability and the amount of time electric assist (e.g., where the electric machine augments torque of an internal combustion engine to meet a driver demand torque) may be provided to the vehicle. In particular, the steering angle may be processed so that a determination may be made as to whether or not a vehicle is exiting a turn. At the exit of a road turn, it may be more beneficial to increase vehicle drivability by providing electric assist to meet driver demand torque than to propel the vehicle via the electric based solely on driver demand torque. For example, a vehicle's driver may perceive that a vehicle exhibits increased drivability when high driver demands that may be exclusively met by both engine torque and electric machine torque at an exit of a road turn as compared to exclusively applying the electric machine to meet lower driver demand torques. This allows electric machine torque to be conserved for conditions where a driver wishes for increased vehicle response and excluded from conditions when driver demand torque can be met exclusively by an engine. Consequently, if a vehicle is operating on a track or road that includes a relatively higher frequency of turns, electric assist may be made available for a longer amount of time.

The present description may provide several advantages. In particular, the approach may increase hybrid vehicle drivability. Further, the approach may be selectively activated according to a particular vehicle operating mode so that driver expectations may be more closely met. Additionally, the approach may increase effectiveness of powertrain torque delivery.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined by the claims that follow the detailed description. Furthermore, the claimed subject matter is not constrained to implementations that solve any disadvantages noted above or in any part of this disclosure.

Referring to FIG. 1, internal combustion engine 10, comprising a plurality of cylinders, one cylinder of which is shown in FIG. 1, is controlled by electronic controller 12 (e.g., an engine controller). Engine 10 is comprised of cylinder head 35 and block 33, which include combustion chamber 30 and cylinder walls 32. Piston 36 is positioned therein and reciprocates via a connection to crankshaft 40. Flywheel 97 and ring gear 99 are coupled to crankshaft 40. Flywheel starter 96 (e.g., low voltage (operated with less than 30 volts) electric machine) includes pinion shaft 98 and pinion gear 95. Pinion shaft 98 may selectively advance pinion gear 95 to engage ring gear 99. Flywheel starter 96 may be directly mounted to the front of the engine or the rear of the engine. In some examples, flywheel starter 96 may selectively supply torque to crankshaft 40 via a linking device. In one example, flywheel starter 96 is in a base state when not engaged to the engine crankshaft 40. Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. The position of intake cam 51 may be determined by intake cam sensor 55. The position of exhaust cam 53 may be determined by exhaust cam sensor 57. Intake valve 52 may be selectively activated and deactivated by valve activation device 59. Exhaust valve 54 may be selectively activated and deactivated by valve activation device 58. Valve activation devices 58 and 59 may be hydraulic and/or electro-mechanical devices.

Fuel injector 66 is shown positioned to inject fuel directly into cylinder 34, which is known to those skilled in the art as direct injection. Fuel injector 66 delivers liquid fuel in proportion to the pulse width from controller 12. Fuel is delivered to fuel injector 66 by a fuel system (not shown) including a fuel tank, fuel pump, and fuel rail (not shown). In one example, a high pressure, dual stage, fuel system may be used to generate higher fuel pressures.

In addition, intake manifold 44 is shown communicating with engine air intake 42. Optional electronic throttle 62 adjusts a position of throttle plate 64 to control air flow from engine air intake 42 to intake manifold 44. In some examples, throttle 62 and throttle plate 64 may be positioned between intake valve 52 and intake manifold 44 such that throttle 62 is a port throttle. Air filter 43 cleans air entering engine air intake 42.

Distributorless ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of catalytic converter 70. Alternatively, a two-state exhaust gas oxygen sensor may be substituted for UEGO sensor 126.

Catalytic converter 70 can include multiple catalyst bricks, in one example. In another example, multiple emission control devices, each with multiple bricks, can be used. Catalytic converter 70 can be a three-way type catalyst in one example. Temperature of catalytic converter 70 (e.g., catalyst) may be monitored via temperature sensor 72.

Controller 12 may receive input data from and provide output data to human/machine interface 160. Human/machine interface 160 may be a touch screen display, key board, or other known interface. Controller 12 may provide and display system status information via human/machine interface 160. A human user may input requests for powertrain and passenger cabin climate controls to human/machine interface 160.

Controller 12 is shown in FIG. 1 as a conventional microcomputer including: microprocessor unit 102, input/output ports 104, read-exclusive memory 106 (e.g., non-transitory memory), random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an driver demand pedal 130 for sensing force applied by foot 132; a position sensor 154 coupled to caliper control pedal 150 for sensing force applied by foot 152, a measurement of engine manifold pressure (MAP) from pressure sensor 122 coupled to intake manifold 44; an engine position sensor from a position sensor 118 sensing crankshaft 40 position; a measurement of air mass entering the engine from sensor 120; and a measurement of throttle position from sensor 68. Barometric pressure may also be sensed (sensor not shown) for processing by controller 12. In a preferred aspect of the present description, position sensor 118 produces a predetermined number of equally spaced pulses each revolution of the crankshaft from which engine speed (RPM) can be determined.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g., when combustion chamber 30 is at its largest volume) is typically referred to by those of skill in the art as bottom dead center (BDC).

During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion.

During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

FIG. 2 is a block diagram of a vehicle 225 including a powertrain or driveline 200. The powertrain of FIG. 2 includes engine 10 shown in FIG. 1. Driveline 200 is shown including vehicle system controller 255, controller 12, electric machine controller 252, transmission controller 254, energy storage device controller 253, and caliper controller 250. The controllers may communicate over controller area network (CAN) 299. In addition, vehicle system controller 255 may communicate with communications system 256 (e.g., a transceiver) so that vehicle 225 may communicate with a remote server (not shown) via cellular network, satellites, vehicle to vehicle communications network, or other radio frequency communications system. Each of the controllers may provide information to other controllers such as power output constraints (e.g., power output of the device or component being controlled not to be exceeded), power input constraints (e.g., power input of the device or component being controlled not to be exceeded), power output of the device being controlled, sensor and actuator data, diagnostic information (e.g., information regarding a degraded transmission, information regarding a degraded engine, information regarding a degraded electric machine, information regarding degraded calipers). Further, the vehicle system controller 255 may provide commands to controller 12, electric machine controller 252, transmission controller 254, and caliper controller 250 to achieve driver input requests and other requests that are based on vehicle operating conditions.

For example, in response to a driver (human or autonomous) releasing a driver demand pedal and vehicle speed, vehicle system controller 255 may request a desired wheel power or a wheel power level to provide a desired rate of vehicle speed reduction. The requested desired wheel power may be provided by vehicle system controller 255 requesting a first wheel caliper power from electric machine controller 252 and a second wheel caliper power from controller 12, the first and second powers providing a desired driveline slowing power at vehicle wheels 216. Vehicle system controller 255 may also request a friction caliper power via caliper controller 250. The caliper powers may be referred to as negative powers since they slow driveline and wheel rotation. Positive power may maintain or increase speed of the driveline and wheel rotation.

In other examples, the partitioning of controlling powertrain devices may be partitioned differently than is shown in FIG. 2. For example, a single controller may take the place of vehicle system controller 255, controller 12, electric machine controller 252, transmission controller 254, and caliper controller 250. Alternatively, the vehicle system controller 255 and the controller 12 may be a single unit while the electric machine controller 252, the transmission controller 254, and the caliper controller 250 are standalone controllers.

In this example, driveline 200 may be powered by engine 10 and electric machine 240. In other examples, engine 10 may be omitted. Engine 10 may be started with an engine starting system shown in FIG. 1 or via electric machine 240 also known as an integrated starter/generator (ISG). Further, power of engine 10 may be adjusted via power actuator 204, such as a fuel injector, throttle, etc.

Driveline 200 is shown to include an electric energy storage device 262. Electric energy storage device 262 may output a higher voltage (e.g., 48 volts) than electric energy storage device 263 (e.g., 12 volts). DC/DC converter 245 may allow exchange of electrical energy between high voltage bus 291 and low voltage bus 292. High voltage bus 291 is electrically coupled to higher voltage electric energy storage device 262. Low voltage bus 292 is electrically coupled to lower voltage electric energy storage device 263 and sensors/actuators/accessories 279. Sensors/actuators/accessories 279 may include but are not constrained to front and rear windshield resistive heaters, vacuum pumps, climate control fans, and lights. Inverter 247 converts DC power to AC power and vice-versa to enable power to be transferred between electric machine 240 and electric energy storage device 262.

An engine output power may be transmitted to an input or first side of driveline disconnect clutch 235 through dual mass flywheel 215. Driveline disconnect clutch 236 may be hydraulically actuated via fluid (e.g., oil) that is pressurized via pump 283. A position of valve 282 (e.g., line pressure control valve) may be modulated to control a pressure (e.g., a line pressure) of fluid that may be supplied to driveline disconnect clutch pressure control valve 281. A position of valve 281 may be modulated to control a pressure of fluid that is supplied to driveline disconnect clutch 235. The downstream or second side 234 of driveline disconnect clutch 236 is shown mechanically coupled to electric machine input shaft 237.

Electric machine 240 may be operated to provide power to driveline 200 or to convert powertrain power into electrical energy to be stored in electric energy storage device 262 in a regeneration mode. Electric machine 240 is in electrical communication with electric energy storage device 262. Electric machine 240 has a higher output power capacity than flywheel starter 96 shown in FIG. 1. Further, electric machine 240 directly drives driveline 200 or is directly driven by driveline 200. There are no gears or chains to couple electric machine 240 to driveline 200. Rather, electric machine 240 rotates at the same rate as driveline 200. Electric energy storage device 262 (e.g., high voltage battery or power source, which may be referred to as a traction battery) may be a battery, capacitor, or inductor. The downstream side of electric machine 240 is mechanically coupled to the torque converter impeller 285 of torque converter 206 via shaft 241. The upstream side of the electric machine 240 is mechanically coupled to the disconnect clutch 236. Electric machine 240 may provide a positive power or a negative power to driveline 200 via operating as a motor or generator as instructed by electric machine controller 252.

Torque converter 206 includes a torque converter turbine 286 to output power to input shaft 270. Input shaft 270 mechanically couples torque converter 206 to automatic transmission 208. Torque converter 206 also includes a torque converter lock-up clutch 212 (TCC). Power is directly transferred from torque converter impeller 285 to torque converter turbine 286 when the TCC is locked. The TCC is electrically operated by transmission controller 254. Alternatively, TCC may be hydraulically locked. In one example, the torque converter may be referred to as a component of the transmission.

When torque converter lock-up clutch 212 is fully disengaged, torque converter 206 transmits engine power to automatic transmission 208 via fluid transfer between the torque converter turbine 286 and torque converter impeller 285, thereby enabling torque multiplication. In contrast, when torque converter lock-up clutch 212 is fully engaged, the engine output power is directly transferred via the torque converter clutch to an input shaft 270 of automatic transmission 208. Alternatively, the torque converter lock-up clutch 212 may be partially engaged, thereby enabling the amount of power directly transferred to the transmission to be adjusted. The transmission controller 254 may be configured to adjust the amount of power transmitted by torque converter lock-up clutch 212 by adjusting the torque converter lock-up clutch in response to various engine operating conditions, or based on a driver-based engine operation request.

Torque converter 206 also includes pump 283 that pressurizes transmission fluid 295 to operate driveline disconnect clutch 236, forward clutch 210, and gear clutches 211. Pump 283 is driven via torque converter impeller 285, which rotates at a same speed as electric machine 240.

Automatic transmission 208 includes gear clutches 211 (e.g., gears 1-10) and forward clutch 210 that may be actuated via transmission fluid 295. Automatic transmission 208 is a fixed ratio transmission. Alternatively, automatic transmission 208 may be a continuously variable transmission that has a capability of simulating a fixed gear ratio transmission and fixed gear ratios. The gear clutches 211 and the forward clutch 210 may be selectively engaged to change a ratio of an actual total number of turns of input shaft 270 to an actual total number of turns of wheels 216. Gear clutches 211 may be engaged or disengaged via adjusting fluid supplied to the clutches via shift control solenoid valves 209. Power output from the automatic transmission 208 may also be relayed to wheels 216 to propel the vehicle via output shaft 260. Specifically, automatic transmission 208 may transfer an input driving power at the input shaft 270 responsive to a vehicle traveling condition before transmitting an output driving power to the wheels 216. Parking pawl 296 may be engaged to prevent motion of output shaft 260 when automatic transmission 208 is in park. Transmission controller 254 selectively activates or engages TCC 212, gear clutches 211, and forward clutch 210. Transmission controller also selectively deactivates or disengages TCC 212, gear clutches 211, and forward clutch 210.

A frictional force may be applied to wheels 216 by engaging friction calipers 218. In one example, friction calipers 218 for wheels 216 may be engaged in response to a human driver pressing their foot on a caliper control pedal (not shown) and/or in response to instructions within caliper controller 250. Further, caliper controller 250 may apply friction calipers 218 in response to information and/or requests made by vehicle system controller 255. In the same way, a frictional force may be reduced to wheels 216 by disengaging friction calipers 218 in response to the human driver releasing their foot from a caliper control pedal, caliper controller instructions, and/or vehicle system controller instructions and/or information. For example, vehicle calipers may apply a frictional force to wheels 216 via caliper controller 250 as part of an automated vehicle stopping procedure. A slowing torque may be determined as a function of caliper control pedal position.

In response to a request to increase a speed of vehicle 225, vehicle system controller may obtain a driver demand power or power request from a driver demand pedal or other device. Vehicle system controller 255 then allocates a fraction of the requested driver demand power to the engine and the remaining fraction to the electric machine. Vehicle system controller 255 requests the engine power from controller 12 and the electric machine power from electric machine controller 252. If the electric machine power plus the engine power is less than a transmission input power threshold (e.g., a threshold value not to be exceeded), the power is delivered to torque converter 206 which then relays at least a fraction of the requested power to transmission input shaft 270. Transmission controller 254 selectively locks torque converter lock-up clutch 212 and engages gears via gear clutches 211 in response to shift schedules and TCC lockup schedules that may be based on input shaft power and vehicle speed. In some conditions when it may be desired to charge electric energy storage device 262, a charging power (e.g., a negative electric machine power) may be requested while a non-zero driver demand power is present. Vehicle system controller 255 may request increased engine power to overcome the charging power to meet the driver demand power.

In response to a request to reduce a speed of vehicle 225 and provide regenerative vehicle slowing, vehicle system controller may provide a negative desired wheel power (e.g., desired or requested powertrain wheel power) based on vehicle speed and caliper control pedal position. Vehicle system controller 255 then allocates a fraction of the negative desired wheel power to the electric machine 240 and the engine 10. Vehicle system controller may also allocate a portion of the requested slowing power to friction calipers 218 (e.g., desired friction caliper wheel power). Further, vehicle system controller may notify transmission controller 254 that the vehicle is in regenerative slowing mode so that transmission controller 254 shifts gears based on a particular shifting schedule to increase regeneration efficiency. Engine 10 and electric machine 240 may supply a negative power to transmission input shaft 270, but negative power provided by electric machine 240 and engine 10 may be constrained by transmission controller 254 which outputs a transmission input shaft negative power threshold (e.g., not to be exceeded threshold value). Further, negative power of electric machine 240 may be constrained (e.g., constrained to less than a threshold negative threshold power) based on operating conditions of electric energy storage device 262, by vehicle system controller 255, or electric machine controller 252. Any portion of desired negative wheel power that may not be provided by electric machine 240 because of transmission or electric machine thresholds may be allocated to engine 10 and/or friction calipers 218 so that the desired wheel power is provided by a combination of negative power (e.g., power absorbed) via friction calipers 218, engine 10, and electric machine 240.

Accordingly, power control of the various powertrain components may be supervised by vehicle system controller 255 with local power control for the engine 10, automatic transmission 208, electric machine 240, and friction calipers 218 provided via controller 12, electric machine controller 252, transmission controller 254, and caliper controller 250.

As one example, an engine power output may be controlled by adjusting a combination of spark timing, fuel pulse width, fuel pulse timing, and/or air charge, by controlling throttle opening and/or valve timing, valve lift and boost for turbo- or super-charged engines. In the case of a diesel engine, controller 12 may control the engine power output by controlling a combination of fuel pulse width, fuel pulse timing, and air charge. Engine slowing power or negative engine power may be provided by rotating the engine with the engine generating power that is insufficient to rotate the engine. Thus, the engine may generate a slowing power via operating at a low power while combusting fuel, with one or more cylinders deactivated (e.g., not combusting fuel), or with all cylinders deactivated and while rotating the engine. The amount of engine slowing power may be adjusted via adjusting engine valve timing. Engine valve timing may be adjusted to increase or decrease engine compression work. Further, engine valve timing may be adjusted to increase or decrease engine expansion work. In all cases, engine control may be performed on a cylinder-by-cylinder basis to control the engine power output.

Electric machine controller 252 may control power output and electrical energy production from electric machine 240 by adjusting current flowing to and from rotor and/or armature windings of electric machine as is known in the art.

Transmission controller 254 receives transmission input shaft position via position sensor 271. Transmission controller 254 may convert transmission input shaft position into input shaft speed via differentiating a signal from position sensor 271 or counting a number of known angular distance pulses over a predetermined time interval. Transmission controller 254 may receive transmission output shaft torque from torque sensor 272. Alternatively, sensor 272 may be a position sensor or torque and position sensors. If sensor 272 is a position sensor, transmission controller 254 may count shaft position pulses over a predetermined time interval to determine transmission output shaft velocity. Transmission controller 254 may also differentiate transmission output shaft velocity to determine transmission output shaft rate of speed change. Transmission controller 254, controller 12, and vehicle system controller 255, may also receive addition transmission information from sensors 277, which may include but are not constrained to pump output line pressure sensors, transmission hydraulic pressure sensors (e.g., gear clutch fluid pressure sensors), a transmission fluid temperature sensor, electric machine temperature sensors, gear selector position sensors, and an ambient temperature sensor. Transmission controller 254 may also receive requested gear input from gear selector 290 (e.g., a human/machine interface device). Gear selector 290 may include positions for gears 1-N (where N is an upper gear number), D (drive), R (reverse), and P (park) as indicated at 293.

Caliper controller 250 receives wheel speed information via wheel speed sensor 221 and slowing requests from vehicle system controller 255. Caliper controller 250 may also receive caliper pedal position information from position sensor 154 shown in FIG. 1 directly or over CAN 299. Caliper controller 250 may provide slowing responsive to a wheel power command from vehicle system controller 255. Caliper controller 250 may also provide anti-lock and vehicle stability to increase vehicle slowing and stability. As such, caliper controller 250 may provide a wheel power threshold (e.g., a threshold negative wheel power not to be exceeded) to the vehicle system controller 255 so that negative electric machine power does not cause the wheel power threshold to be exceeded. For example, if caliper controller 250 issues a negative wheel power threshold of 50 N-m, electric machine power is adjusted to provide less than 50 N-m (e.g., 49 N-m) of negative power at the wheels, including accounting for transmission gearing.

Vehicle 225 may also include a steering wheel 213. A human driver may rotate steering wheel 213 to generate a steering angle of the vehicle's front wheels (not shown), thereby causing the vehicle to travel straight or turn. Steering angle sensor 214 may be coupled to steering wheel 213 or to steering linkage (not shown) to determine the vehicle's steering angle. Steering angle sensor 214 may generate a steering angle signal 219 that indicates steering angle and that may be input to one or more controllers (e.g., vehicle system controller 255 or electric machine controller 252). When the vehicle is traveling in a straight line and the steering wheel is at its centered position, the steering angle as determined via a steering wheel sensor may be zero. Alternatively, the vehicle's steering angle may be determined via a sensor that monitors a vehicle's steering pinion angle or a sensor that monitors a castor angle of the vehicle's wheels as shown in FIGS. 5A and 5B.

Thus, the system of FIGS. 1 and 2 provides for a system, comprising: an internal combustion engine; an electric machine; and a controller including executable instructions stored in non-transitory memory that cause the controller to assist torque output of the internal combustion engine via the electric machine in response to an indication that a vehicle that includes the internal combustion engine is exiting a turn. In a first example, the system includes where the indication is based on a first result of a difference between an output of a first filter and an output of a second filter, and further comprising additional executable instructions that cause the controller to input a steering angle to the first filter and the second filter. In a second example that may include the first example, the system further comprises additional executable instructions that cause the controller to generate a gain value based on the first result. In a third example that may include one or both of the first and second examples, the system further comprises additional executable instructions that cause the controller to multiply a maximum electric machine torque by the gain value to generate a second result. In a fourth example that may include one or more of the first through third examples, the system further comprises additional executable instructions that cause the controller to adjust a torque output of the electric machine in response to the second result. In a fifth example that may include one or more of the first through fourth examples, the system further comprises additional instructions to constrain a rate of increase of the torque output of the electric machine in response to an amount of time the first result exceeds a threshold amount. In a sixth example that may include one or more of the first through fifth examples, the system further comprises additional instructions to decrease the torque output of the electric machine in response to the first result being constant or decreasing.

Referring now to FIG. 3, a prophetic vehicle operating sequence is shown. The operating sequence of FIG. 3 may be provided via the system of FIGS. 1 and 2 in cooperation with the method of FIG. 4. The vertical lines at times t0-t3 represent times of interest during the operating sequence. The plots are time aligned and the vehicle (not shown) of the vehicle operating sequence is traveling on a road.

The first plot from the top of FIG. 3 is a plot of unfiltered vehicle steering angle versus time. The vertical axis represents the unfiltered vehicle steering angle in degrees. The horizontal axis represents time and time increases from the left side of the plot to the right side of the plot. Trace 302 represents the unfiltered vehicle steering angle.

The second plot from the top of FIG. 3 is a plot of fast filtered vehicle steering angle versus time. The vertical axis represents the fast filtered vehicle steering angle in degrees. The horizontal axis represents time and time increases from the left side of the plot to the right side of the plot. Trace 304 represents the fast filtered vehicle steering angle. In one example, the steering angle may be filtered via a low pass digital filter of the form Y(k)=α1U(k)+(1−α1)Y(k−1), where k is a signal sample number, Y is filter output value, U is filter input value, and α1 is a fast filtering factor. The low pass filter may be described as fast filtering the vehicle steering angle signal when the low pass filter's cut-off frequency (e.g., frequency at which the steering angle signal is attenuated −3 dB) is greater than a threshold frequency (e.g., 20 Hertz). The fast filtering factor α1 is related to the cut-off frequency via the following equation α1=1−e^{-ω}^{_{c}}^{·T}^{ₛ}, where ω_{c} is the cut-off frequency of the low pass filter, e is Euler's number, and Tₛ is the sample time of the low pass filter. The low pass filter may be implemented via the controller that receives the unfiltered steering angle signal.

The third plot from the top of FIG. 3 is a plot of slow filtered vehicle steering angle versus time. The vertical axis represents the fast filtered vehicle steering angle in degrees. The horizontal axis represents time and time increases from the left side of the plot to the right side of the plot. Trace 306 represents the slow filtered vehicle steering angle. In one example, the vehicle steering angle may be filtered via a low pass digital filter of the form Y(k)=α2U(k)+(1−α2)Y(k−1), where k is a signal sample number, Y is filter output value, U is filter input value, and α2 is a slow filtering factor. The low pass filter may be described as slow filtering the vehicle steering angle signal when the low pass filter's cut-off frequency (e.g., frequency at which the steering angle signal is attenuated −3 dB) is less than a threshold frequency (e.g., 10 Hertz).

The fourth plot from the top of FIG. 3 is a plot of traction motor or electric machine torque gain (e.g., a real number that may range between 0 and 1) versus time. The vertical axis represents the traction motor or electric machine gain. The horizontal axis represents time and time increases from the left side of the plot to the right side of the plot. Trace 308 represents the traction motor or electric machine gain.

At time t0, the unfiltered vehicle steering angle is zero (e.g., the vehicle's front wheels are facing straight forward so that the vehicle travels in a straight line), the fast filtered vehicle steering angle is zero, the slow filtered vehicle steering angle is zero, and the traction motor gain is approximately 0.2. The 0.2 traction motor gain may be multiplied by the maximum traction motor torque value to determine the amount of torque that the traction motor may provide to the driveline.

At time t1, the unfiltered vehicle steering angle begins to increase. The fast filtered vehicle steering angle begins to increase shortly after time t1. The slow filtered vehicle steering angle also begins to increase after time t1, but with a lower rate of increase as compared to the fast filtered vehicle steering angle. The traction motor gain remains at approximately 0.2.

Between time t1 and time t2, the unfiltered vehicle steering angle reaches a threshold angle and remains at this angle. The fast filtered vehicle steering angle has reached the same threshold angle as the unfiltered vehicle steering angle and the fast filtered vehicle steering angle remains at this angle. Likewise, the slow filtered vehicle steering angle has also reached the same threshold angle as the unfiltered vehicle steering angle and the slow filtered vehicle steering angle remains at this angle. The traction motor gain remains at approximately 0.2.

At time t2, the unfiltered vehicle steering angle begins to decrease. The fast filtered vehicle steering angle begins to decrease shortly after time t2. The slow filtered vehicle steering angle also begins to decrease after time t2, but with a lower rate of increase as compared to the fast filtered vehicle steering angle. The traction motor gain begins to increase in response to the difference in angle between the slow filtered vehicle steering angle and the fast filtered vehicle steering angle. As a result, the electric machine gain now begins to increase based on the vehicle steering angle.

At time t3, the unfiltered vehicle steering angle has returned to zero degrees and both the fast filtered vehicle steering angle and the slow filtered vehicle steering angle continue to be reduced toward zero. The traction motor gain continues to increase as the difference between the slow filtered vehicle steering angle and the fast filtered vehicle steering angle increases.

Between time t3 and time t4, the traction motor gain reaches its highest level during the sequence and then it begins to decline. The fast filtered vehicle steering angle and the slow filtered vehicle steering angle continue to decrease. The unfiltered vehicle steering angle remains at zero.

At time t4, the fast filtered vehicle steering angle reaches zero and the slow filtered vehicle steering angle continues to decrease. The traction motor gain also continues to decrease, and since the fast filtered vehicle steering angle is zero, the traction motor gain trajectory is similar to the slow filtered vehicle steering angle. The unfiltered vehicle steering angle remains at zero.

At time t5, the slow filtered vehicle steering angle reaches zero and the traction motor gain reaches the level that it assumed before time t1. As such, the electric machine gain is not increased or decreased based on the vehicle steering angle.

In this way, a traction motor gain and traction motor torque may be adjusted according to vehicle steering angle. As a vehicle begins to enter a turn as shown beginning at time t1, traction motor gain and traction motor torque are not adjusted according to the unfiltered vehicle steering angle or the slow and fast filtered vehicle steering angles. Instead, as the vehicle begins to exit the turn at time t2, traction motor gain and traction motor torque may be adjusted according to the unfiltered vehicle steering angle, the slow filtered vehicle steering angle, and the fast filtered vehicle steering angle. This allows battery power to be conserved for a time and conditions where it may be very beneficial to increase vehicle drivability by increasing vehicle performance at an exit of a turn. Such operation may be desirable when the vehicle is operating in a sport mode or on a road that includes a relatively large number of turns in a relatively short driving distance.

Referring now to FIG. 4, a block diagram 400 of a method for operating a hybrid vehicle is shown. The method of FIG. 4 may be at least partially implemented as executable instructions stored in controller memory in the system of FIGS. 1 and 2. Further, the method of FIG. 4 may include actions taken in the physical world to transform an operating state of the system of FIGS. 1 and 2. Additionally, the method of FIG. 4 may provide at least portions of the operating sequence shown in FIG. 3. Method 400 may be performed while a hybrid vehicle is being operated in a sport mode (e.g., a mode where vehicle performance may be increased over base vehicle operation) and sporty driving maneuvers are being performed (e.g., a larger number of turns are performed in a relatively short amount of time, such as three or more vehicle turns in less than a minute, and driver demand torque exiting the turns exceeds a threshold driver demand torque).

At block 402, an unfiltered or raw vehicle steering angle signal is received from sensor 214. Block 402 passes positive angles from the unfiltered vehicle steering angle signal to blocks 404 and 406. Block 402 changes the sign and retains the magnitude of negative steering angles that are received from sensor 214. Thus, block 402 outputs solely positive value steering angles with magnitudes that are not modified from raw steering angle values. This allows the traction motor gain to respond to right and left angles in a similar way.

At block 404, the positive raw or unfiltered steering angle is received and processed via a low pass filter based on the fast filtering factor α1. The low pass filter may be of the form Y(k)=α1U(k)+(1−α1)Y(k−1) as previously described. Block 404 outputs a low pass filtered vehicle steering angle that may be referred to as a fast filtered vehicle steering angle to block 408 via a filter output.

At block 406, the positive raw or unfiltered steering angle is received and processed via a low pass filter based on the slow filtering factor α2. The low pass filter may be of the form Y(k)=α2U(k)+(1−α2)Y(k−1) as previously described. Block 404 outputs a low pass filtered vehicle steering angle that may be referred to as a slow filtered vehicle steering angle to block 408 via a filter output.

At block 408, method 400 subtracts the fast filtered vehicle steering angle that is output from block 404 from the slow filtered vehicle steering angle that is output of block 404. The result of the subtraction is input to block 410, block 412, and block 414. Negative values output from block 408 indicate that the vehicle is entering a turn. Positive values output from block 408 indicate that the vehicle is exiting the turn.

At block 410, the output of block 408 (a difference between the low pass filter output and the high pass filter output) is applied to reference or index a table or function that outputs a traction motor or electric machine gain value. The traction motor gain or electric machine gain increases as the output of block 408 increases. Block 410 outputs a traction motor gain or an electric machine gain value to block 430.

At block 412, it is judged whether or not the output of block 408 is greater than a predetermined threshold value for setting a timer. If so, block 412 outputs a value of one or a TRUE logical state to block 416. If not, block 412 outputs a value of zero or a FALSE logical state to block 416.

At block 414, it is judged whether or not the output of block 408 is less than or equal to a predetermined threshold value for resetting the timer. If so, block 414 outputs a value of one or a TRUE logical state to block 416. If not, block 412 outputs a value of zero or a FALSE logical state to block 416.

At block 416, a timer is activated and counting if the output of block 412 is true or one and the output of block 414 is false or zero. The timer is reset to a value of zero if the output of block 414 is true or one. Block 416 outputs a count value or an amount of time to block 418.

At block 418, it is judges whether or not the output of block 416 (an amount of time) is greater than a predetermined verification time. If so, a TRUE indication is output of block 418. If not, a FALSE indication is output of block 418. The output of block 418 is input to block 420.

At block 420, the output of block 418 is applied to determine whether to output a maximum increment value or a value of zero. In particular, if the output of block 418 is TRUE, block 420 operates as a switch and outputs a maximum increment value. If the output of block 418 is FALSE, block 420 outputs a value of zero. The output of block 420 is input to block 430.

At block 430, constraints to the rate of traction motor gain or electric machine gain may be applied. Block 430 may operate to constrain a rate of change of the traction gain, which may be determined as: Rate_Gain=u(i)−y(i−1)/t(i)−t(i−1), where u is the traction motor gain or electric machine gain output from block 410, y is output of block 430, i is present data sample number, and t is time. If the value of Rate_Gain exceeds a threshold value R, output of block 430 is y(i)=(t(i)−t(i−1))·R+y(i−1), where y is the output of block 430, is the present data sample number, t is time, and R is a threshold rate of traction motor gain. If the value of Rate_Gain is less than a threshold value F, output of block 430 is y(i)=(t(i)−t(i−1))·F+y(i−1), where y is the output of block 430, is the present data sample number, t is time, and F is a threshold rate of traction motor gain. If the value of Rate_Gain is not greater than R or if the value of Rate_Gain is not less than F, then y(i)=u(i). The output of block 430 may be described as a rate constrained traction motor gain or a rate constrained electric machine gain. In one example, the output of block 430 may be multiplied by the maximum traction motor torque or maximum electric machine torque and stored in controller memory as a variable MtrGen2Allw. If the vehicle's human driver requests less torque than max_eng_tq (maximum engine torque)+MtrGen2Allw, then the engine and the electric machine provide the requested torque. However, if the vehicle's human driver requests more torque than max_eng_tq+MtrGen2Allw torque, the torque that is delivered via the engine and the electric machine is constrained to max_eng_tq+MtrGen2Allw torque.

In this way, the method of FIG. 4 may adjust an electric machine torque gain or a traction motor torque gain in response to a vehicle steering angle. In particular, the method of FIG. 4 may adjust electric machine torque or traction motor torque according to a difference between a slow filtered vehicle steering angle and a fast filtered vehicle steering angle. This allows the controller to discern the vehicle entering a turn from exiting a turn so that the controller may adjust the traction motor torque gain or electric machine torque gain at a time when the adjustment may increase vehicle drivability in a desired way.

Thus, method 400 provides for a method for operating a vehicle, comprising: via a controller, adjusting output of an electric machine that propels the vehicle in response to a steering angle of the vehicle. In a first example, the method further comprises filtering a steering angle signal via a first filter and a second filter, the first filter including a first filter factor, the second filter including a second filter factor, the first time constant smaller than the second time constant. In a second example that may include the first example, the method further comprises subtracting output of the first filter from output of the second filter to generate a first result. In a third example that may include one or both of the first and second examples, the method further comprises selecting an electric machine gain value in response to the first result. In a fourth example that may include one or more of the first through third examples, the method further comprises constraining a rate of increase of the first result to a first rate. In a fifth example that may include one or more of the first through fourth examples, the method further comprises constraining a rate of decrease of the first result to a second rate. In a sixth example that may include one or more of the first through fifth examples, the method includes where adjusting output of the electric machine that propels the vehicle in response to the steering angle of the vehicle includes adjusting output of the electric machine in response to the first result. In a seventh example that may include one or more of the first through sixth examples, the method includes where adjusting output of the electric machine includes increasing torque output of the electric machine in response to the steering angle increasing.

Method 400 also provides for a method for operating a vehicle, comprising: via a controller, adjusting output of an electric machine that propels the vehicle in response to a rate constrained electric machine torque gain value, the rate constrained electric machine torque gain value based on a steering angle of the vehicle. In a first example, the method includes where the rate constrained electric machine torque gain value increases in response to a difference between output of a first filter being greater than output of a second filter for a predetermined amount of time. In a second example that may include the first example, the method includes where the rate constrained electric machine torque gain value decreases in response to the difference between output of the first filter being less than or equal to output of the second filter. In a third example that may include one or both of the first and second examples, the method includes where adjusting output of the electric machine is performed while an internal combustion of the vehicle is operating. In a fourth example that may include one or more of the first through third examples, the method includes where the rate constrained electric machine torque gain is constrained between values of zero and one.

Referring now to FIG. 5A, a schematic showing vehicle 225 operating with a steering angle of zero degrees is shown. Longitudinal axis 500 of vehicle 225 is shown bisecting vehicle 225 for the length of vehicle 225. Each of wheels 550a and 550b include longitudinal axis that are parallel with vehicle longitudinal axis 500. The longitudinal axis 502 of wheels 550a and 550b turn as wheels 550a and 550b turn. In this example, the angle between the wheel longitudinal axis 502 and the vehicle longitudinal axis 500 is the steering angle. In this example, the steering angle is zero since wheel longitudinal axis 502 is parallel with vehicle longitudinal axis 500. Vehicle 225 travels in a straight path when the wheel longitudinal axis 502 is in parallel with the vehicle longitudinal axis 500.

Referring now to FIG. 5B, a schematic showing vehicle 225 operating with a steering angle of e degrees is shown. As shown in FIG. 5A, longitudinal axis 500 of vehicle 225 is shown bisecting vehicle 225 for the length of vehicle 225. Wheel longitudinal axis 502 for each of wheels 550a and 550b are not parallel with vehicle longitudinal axis 500. Rather, wheel longitudinal axes 502 are oriented at an angle θ from vehicle longitudinal axis 500. The angle θ is shown at 505 for each of wheel 550a and wheel 550b. In this example, the angle θ between the wheel longitudinal axis 502 and the vehicle longitudinal axis 500 is the steering angle. The angle between where wheel axis 502 is parallel with vehicle longitudinal axis 500 and the wheel axis 502 when wheels 550a and 550b are turned may also be referred to as the steering angle.

Note that the example control and estimation routines included herein can be used with various engine and/or vehicle system configurations. Further, the methods described herein may be a combination of actions taken by a controller in the physical world and instructions within the controller. At least portions of the control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller

This concludes the description. The reading of it by those skilled in the art would bring to mind many alterations and modifications without departing from the spirit and the scope of the description. For example, I3, I4, I5, V6, V8, V10, and V12 engines operating in natural gas, gasoline, diesel, or alternative fuel configurations could use the present description to advantage.

1. A method for operating a vehicle, comprising:
via a controller, adjusting output of an electric machine that propels the vehicle in response to a steering angle of the vehicle.

2. The method of claim 1, further comprising filtering a steering angle signal via a first filter and a second filter, the first filter including a first filter factor, the second filter including a second filter factor, the first time constant smaller than the second time constant.

3. The method of claim 2, further comprising subtracting output of the first filter from output of the second filter to generate a first result.

4. The method of claim 3, further comprising selecting an electric machine gain value in response to the first result.

5. The method of claim 4, further comprising constraining a rate of increase of the first result to a first rate.

6. The method of claim 4, further comprising constraining a rate of decrease of the first result to a second rate.

7. The method of claim 6, where adjusting output of the electric machine that propels the vehicle in response to the steering angle of the vehicle includes adjusting output of the electric machine in response to the first result.

8. The method of claim 7, where adjusting output of the electric machine includes increasing torque output of the electric machine in response to the steering angle increasing.

9. A system, comprising:
an internal combustion engine;
an electric machine; and
a controller including executable instructions stored in non-transitory memory that cause the controller to assist torque output of the internal combustion engine via the electric machine in response to an indication that a vehicle that includes the internal combustion engine is exiting a turn of a road.

10. The system of claim 9, where the indication is based on a first result of a difference between a first filter output and a second filter output, and further comprising additional executable instructions that cause the controller to input a steering angle to a first filter and a second filter.

11. The system of claim 10, further comprising additional executable instructions that cause the controller to generate a gain value based on the first result.

12. The system of claim 11, further comprising additional executable instructions that cause the controller to multiply a maximum electric machine torque by the gain value to generate a second result.

13. The system of claim 12, further comprising additional executable instructions that cause the controller to adjust electric machine torque output in response to the second result.

14. The system of claim 13, further comprising additional instructions to constrain a rate of increase of the torque output of the electric machine in response to an amount of time the first result exceeds a threshold amount.

15. The system of claim 14, further comprising additional instructions to decrease the torque output of the electric machine in response to the first result being constant or decreasing.

16. A method for operating a vehicle, comprising:
via a controller, adjusting output of an electric machine that propels the vehicle in response to a rate constrained electric machine torque gain value, the rate constrained electric machine torque gain value based on a steering angle of the vehicle.

17. The method of claim 16, where the rate constrained electric machine torque gain value increases in response to a difference between output of a first filter being greater than output of a second filter for a predetermined amount of time.

18. The method of claim 17, where the rate constrained electric machine torque gain value decreases in response to the difference between output of the first filter being less than or equal to output of the second filter.

19. The method of claim 16, where adjusting output of the electric machine is performed while an internal combustion of the vehicle is operating.

20. The method of claim 16, where the rate constrained electric machine torque gain value is constrained between values of zero and one.
